(19) United States
(12) Patent Application Publication
(10) Pub. No.: US 2025/0004933 A1
(43) Pub. Date: Jan. 2, 2025

(54) Ranking Test Cases for a Test of a Release of an Application

(71) Applicant: Telefonaktiebolaget LM Ericsson (publ), Stockholm (SE)

(72) Inventors: Mainul Abedin, West Bengal (IN); Swati Swagatika Rout, West Bengal (IN); Soumaditya Goswami, West Bengal (IN)

(21) Appl. No.: 18/690,581

(22) PCT Filed: Aug. 27, 2022
(86) PCT No.: PCT/IN2022/050762

§ 371 Date: Mar. 8, 2024

(30) Foreign Application Priority Data
Sep. 10, 2021 (IN) 202111041081

(51) Int. Cl. G06F 11/36

(52) U.S. Cl. CPC G06F 11/3688; G06F 11/368

(57) ABSTRACT

A method automatically performed by a network node for ranking test cases for a test of a release of an application in a communication network is provided. The method includes calculating (701) a value representing a prioritization for a test case based on (i) a factor having an influence on the test case obtained from data for the test case including a user story, (ii) a first weight assigned to the factor, and (iii) a second weight for the user story based on a defect in the user story. The method further includes deciding (703) an importance of the test case based on the value. The method further includes ranking (705) the test case based on the decision; and outputting (707) a test plan based on the ranking of the test case.

### TECHNICAL FIELD

The present disclosure relates generally to methods for ranking test cases for a test of a release of an application in a communication network, and related methods and apparatuses.

### BACKGROUND

One of the major challenges of software testing is test automation which may be a cost and time-consuming process. See e.g., U.S. Pat. No. 10,423,519. Software testing includes planning, developing, and executing relevant test cases with a goal of verifying and validating a system under test. During a test planning phase, a number of test cases are typically planned (e.g., a significant number), with each test case requiring testing and passing successfully. In addition to performing software testing manually, there are endeavors to automate it. Automated testing may be used to expedite the software testing process while simultaneously increasing testing coverage.

There currently exist certain challenges before test automation can be applied in Software Testing Life Cycle (STLC) including, for example: Demanding skilled resources; high upfront investment costs; selecting an appropriate tool; effective communicating and collaborating in a testing team; and selecting an appropriate testing approach.

In manual testing prior to execution, identifying significant test cases properly is a tedious and time-consuming task. For example, testers typically execute a large number of test cases rather than the intended target prioritization of test cases. A lack of setting priorities against test cases may lead to an erroneous test plan. Aside from new test cases written particularly to cover newly introduced functionality, test subject matter experts (SMEs) may frequently fail to optimize regression test suites by early prediction of the most influential sections of any set of application(s) under test. Although test automation is still a time-consuming procedure, using Artificial Intelligence (AI) and Machine Learning (ML) technology for test automation purposes may reduce human effort, and therefore may improve testing quality and lower costs.

### SUMMARY

There currently exist certain challenges, however, with some approaches using AI and ML including, e.g., lacking identification of impactful test cases, lacking an executable test script, domain dependence, and lacking analysis of specifications written in a natural language (e.g., English) or in multiple natural languages (e.g., English, Spanish, etc.).

Certain aspects of the disclosure and their embodiments may provide solutions to these or other challenges.

In various embodiments, a method automatically performed by a network node for ranking test cases for a test of a release of an application in a communication network is provided. The method includes calculating a value representing a prioritization for a test case based on (i) at least one factor having an influence on the test case. The at least one factor is obtained from data for the test case and the data includes a user story; (ii) a first weight assigned to the at least one factor; and (iii) a second weight for the user story based on a defect in the user story. The method further includes deciding a decision about an importance of the test case based on the value representing a prioritization for the at least one test case. The method further includes ranking the test case based on the decision. The method further includes outputting a test plan based on the ranking of the test case.

In other embodiments, a network node for automatically performing ranking of test cases for a test of for a release of an application in a communication network is provided. The network node includes at least one processor; and at least one memory connected to the at least one processor and storing program code that is executed by the at least one processor to perform operations. The operations include calculation of a value representing a prioritization for a test case based on (i) at least one factor having an influence on the test case. The at least one factor is obtained from data for the test case and the data includes a user story; (ii) a first weight assigned to the at least one factor; and (iii) a second weight for the user story based on a defect in the user story. The operations further include a decision about an importance of the test case based on the value representing a prioritization for the at least one test case. The operations further include a rank of the test case based on the decision. The operations further include an output of a test plan based on the ranking of the test case.

In other embodiments, a network node for automatically performing ranking of test cases for a release of an application in a communication network is provided. The network node is adapted to perform operations. The operations include calculation of a value representing a prioritization for a test case based on (i) at least one factor having an influence on the test case. The at least one factor is obtained from data for the test case and the data includes a user story; (ii) a first weight assigned to the at least one factor; and (iii) a second weight for the user story based on a defect in the user story. The operations further include a decision about an importance of the test case based on the value representing a prioritization for the at least one test case. The operations further include a rank of the test case based on the decision. The operations further include an output of a test plan based on the ranking of the test case.

In other embodiments, a network node for automatically performing ranking of test cases for a release of an application in a communication network is provided, the network node includes a calculating module for calculating a value representing a prioritization for a test case based on (i) at least one factor having an influence on the test case. The at least one factor is obtained from data for the test case and the data includes a user story; (ii) a first weight assigned to the at least one factor; and (iii) a second weight for the user story based on a defect in the user story. The network node further includes a decision module for deciding a decision about an importance of the test case based on the value representing a prioritization for the at least one test case. The network node further includes a ranking module for ranking the test case based on the decision. The network node further includes an outputting module for outputting a test plan based on the ranking of the test case.

In other embodiments, a computer program comprising program code to be executed by processing circuitry of a network node is provided, whereby execution of the program code causes the network node to perform operations. The operations include calculation of a value representing a prioritization for a test case based on (i) at least one factor having an influence on the test case. The at least one factor is obtained from data for the test case and the data including a user story; (ii) a first weight assigned to the at least one factor; and (iii) a second weight for the user story based on a defect in the user story. The operations further include a decision about an importance of the test case based on the value representing a prioritization for the at least one test case. The operations further include a rank of the test case based on the decision. The operations further include an output of a test plan based on the ranking of the test case.

In other embodiments, a computer program product comprising a non-transitory storage medium including program code to be executed by processing circuitry of a network node is provided, whereby execution of the program code causes the network node to perform operations. The operations include calculation of a value representing a prioritization for a test case based on (i) at least one factor having an influence on the test case. The at least one factor is obtained from data for the test case and the data includes a user story; (ii) a first weight assigned to the at least one factor; and (iii) a second weight for the user story based on a defect in the user story. The operations further include a decision about an importance of the test case based on the value representing a prioritization for the at least one test case. The operations further include a rank of the test case based on the decision. The operations further include an output of a test plan based on the ranking of the test case.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating operations of a network node in a communication network in accordance with some embodiments of the present disclosure;

FIG. 2 is a flowchart illustrating operations of a network node in accordance with some embodiments of the present disclosure;

FIG. 3 is a flowchart illustrating operations of a network node in accordance with some embodiments of the present disclosure;

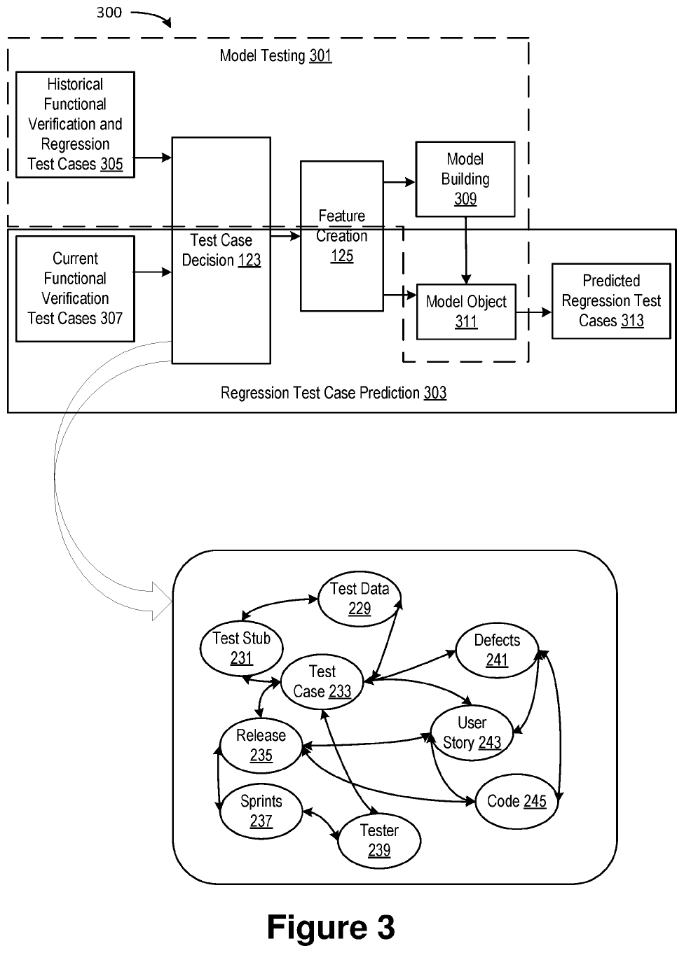

FIG. 4 is a block diagram illustrating a deployment structure in accordance with some embodiments of the present disclosure;

FIG. 5 is a block diagram illustrating a network node according to some embodiments of the present disclosure;

FIG. 6 is a block diagram of a virtualization environment in accordance with some embodiments of the present disclosure; and

FIGS. 7 and 8 are flow charts illustrating operations of a network node according to some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In a conventional Software Testing Life Cycle (STLC), during a test planning phase, a test manager or test lead identifies the test cases that are the most important scenarios that cover essential functionality of an application(s) for future test execution based on his or her expertise. This process is time consuming and may suffer from human judgment, uncertainty, and ambiguity. On the other hand, prioritizing suitable test cases and test scripts for a release test plan, often demands deep domain expertise, and it may be difficult to adapt past knowledge for test execution to ensure all impactful test cases are run. In this sense, an AI/ML solution may be an approach for reducing menial tasks and boosting test accuracy.

Potential challenges, however, exist. In one approach, test cases may be evaluated for testing a software product based a change to code. The output is not executable code, and the output has dependency on the code change information. Additionally, access to the code is needed. See e.g., U.S. Pat. No. 10,423,519. In another approach, a user graphically composes software and configures a number of tests, or test suites, to validate the operation of software. Such an approach provides a test execution framework but lacks selection of test cases for execution. See e.g., U.S. Pat. No. 7,526,681. In another approach, test case information may be sent by a client for predicting a failing test case. Predicting a regression test suite (e.g., a set of test cases for ensuring that software is accurate after undergoing corrections or changes), however, is not provided. See e.g., Ben Linders, et al., “Predicting Failing Tests with Machine Learning”, InfoQ, May 2020, https://www.infoq.com/news/2020/05/predicting-failing-tests/ (accessed on 8 Sep. 2021). Another approach uses manual tasks based on release notes, a defect file, etc., and lacks automation. See e.g., Remo Lachmann et al., “Machine Learning-Driven Test Case Prioritization Approaches for Black-Box Software Testing”, June 2018, https://www.ama-science.org/proceedings/details/2832 (accessed on 8 Sep. 2021). In another approach, Web application code base access is used to identify test cases. Often, however, a tester does not have access to an application developed code base (e.g., in multi-vendor projects). See e.g., Phetmanee, Surasal et al., “A tool for Impact Analysis of Test Cases Based on Changes of a Web Application”, Proceedings of the International MultiConference of Engineers and Computer Scientists (IMECS 2014), Mar. 12-14, 2014.

Such approaches lack providing an executable test script and, instead, propose an abstract guideline to testers for generating test scripts manually. Further, such approaches are domain-dependent and lack applicability in a new domain. Moreover, such approaches lack ability to analyze and parse requirement specifications that are not written in a formal language and, instead, are written in the English language or in different languages rather than the English language.

Various embodiments of the present disclosure include pre-processing of input files (e.g., raw input files such as a defect dump, a test case dump) from a natural language to a machine understandable format. Factors can be extracted from the pre-processed data to identify a ranking of test cases and criticality insights. An output is automatically provided that can include analysis of defect data and includes the ranked test cases. The method may provide test automation that reads and analyzes test specifications written in multiple languages. The test specifications include user story data, historical defect data, user story and test case mapping as input and the output of the method includes a collection of impactful test cases. An AI/ML-based algorithm(s) is also included.

Performance of the method has been evaluated with 800 test cases in the telecommunications domain on fourth generation (4G) and fifth generation (5G) products. Empirical study of the test cases indicates that employing the method in the telecommunications domain yields good results, as described further herein.

In various embodiments, a method for automating a testing process in a communication network is provided. In the method, test cases are ranked for testing a release of an application (which may alternatively be called software instances, virtual appliances, network functions, virtual nodes, virtual network functions, etc.). The ranking identifies important (e.g., impactful) test cases for execution, and predicts criticality insight to identify hotpots in an application. These operations may also be referred to herein as test case prediction and criticality insights (TPCI). A single output is generated in a displayable format (e.g., a test planning report in Excel format). In some embodiments, the method constantly analyzes defect data and test requirements and produces a test plan report with a list of test cases as the final output.

Some embodiments include the following operations. Input data is obtained that includes defect data and an associated test specification of a network node(s). The input data can include a defect summary and test cases described in natural language, without using formal structure and can include information in a set of different languages, such as English, Spanish, Portuguese, Swedish, etc. Impactful test cases are recommended based on a previous severity-based defect distribution and establishing test case priority. A ranking of test cases is generated, e.g., a test plan report that includes a list of impactful test cases as well as an identification of application hotspots that may aid with, or assure, criticality insights.

Various embodiments generate impactful test cases based on prior user stories and historical faults raised for those user stories. A user story can capture a description of a software feature from a user's perspective. The user story describes, e.g., the type of user, what they want, and why. A user story can help to create a simplified description of a requirement. In some embodiments, identifying impactful user stories (e.g., to be part of regression suite) is based on parameters such as severities of the historical defects, story points, a user story creation date, a user story deployed date, sprint details (e.g., a set period of time during which specific work has to be completed and made ready for review), etc. A story point includes a metric used to estimate the difficulty of implementing a given user story. which is an abstract measure of effort needed to implement it. For example, a story point can be a number that tells a tester or team about the difficulty level of the story. Difficulty can be related to, e.g., complexities, risks, and efforts involved.

Some embodiments include operations to identify test cases for newly deployed user stories of a current sprint where defects are not yet raised or identified for the newly deployed user story or user stories.

In some embodiments, AI-based support vector classifier (SVC) aids in categorization of user stories, which may solve classification and regression problems.

For some embodiments, by only providing user stories and defect data, hassle free test planning may be provided for stake holders. For example, in some embodiments, the method generates the test plan and sends the test plan via mail notification to a user.

In some embodiments, an automation script is used to process unstructured input data from different projects and convert it into input data sets that can be used by the method. As a consequence, the method may be flexible and may be used in different projects with minimal human effort.

Some embodiments include a feedback operation in which a model constantly learns from every sprint/release.

As discussed further herein, in various embodiments, a network node performs the method. The network node includes at least one processor; and at least one memory connected to the at least one processor and storing program code that is executed by the at least one processor to perform operations of the method. In some embodiments, the program code is written in a programming language, e.g., Python.

Certain embodiments may provide one or more of the following technical advantages. Impactful test (e.g., most impactful) cases to be part of a regression suite based on factors such as defects, story points, user story are identified. By including identification of impactful test cases for execution (e.g., automated execution) and/or identification of insight into application hotspots (e.g., criticality insight for faults or defects raised with their severities), processing time and human effort may be reduced (e.g., from days to seconds). The identification may be automatically generated, and thus may eliminate some irrelevant information and/or manual work associated with software testing. Inclusion of weightages of user stories (e.g., every user story) for the application may aid in identifying impactful test cases. Inclusion of output of an SVC as input to the method may aid in the categorization of user stories to solve classification and regression problems. Also, the method may overcome domain dependence and can be applicable for various communication networks including, without limitation, 4G and 5G telecommunications products, as well as for new products such as sixth generation (6G) products. A further potential advantage may be applicability of the method to another emerging area. That is, based on transforming specifications and other test data from natural language to a machine-readable format, flexibility may be achieved to use the method with different projects through conversion of input data into data sets that can be used by the method.

Certain embodiments may provide one or more of the following additional technical advantages. An AI-based framework is used that may completely automate a test planning phase in which a group of impactful test cases corresponding to each release for test execution are identified in a test plan. The test plan can be a test plan report that includes both new test cases and identified existing impactful test cases. Additionally, application hotspot areas can be identified for criticality insights in upcoming release testing. The test plan can be executed in an automatic way, or an individual can evaluate the test plan and provide the test plan for a next phase of a STLC for test execution. The method supports various languages, including Spanish, Portuguese, Swedish, English, etc. A confidence score can be provided in the output for the identified test cases. The method, including its output, may assist a user in optimizing performance criteria via experience. Additionally, prior dynamic feedback adjustment can be applied for matching a score for predicted test specification to improve recommendations.

As a consequence of inclusion of such features, processing demands, time, and human effort may be reduced (e.g., from hours to seconds). Test planning may be simplified; automation for a testing procedure from scratch (e.g., a planning phase) may be enabled; manual efforts may be reduced for finding effective test cases from a bigger test case bank with high or higher accuracy; human-related experience and biasness may be separated from prioritizing test cases; and the method and network node may be deployable in any testing environment, as well as being compatible with new technologies, such as 6G.

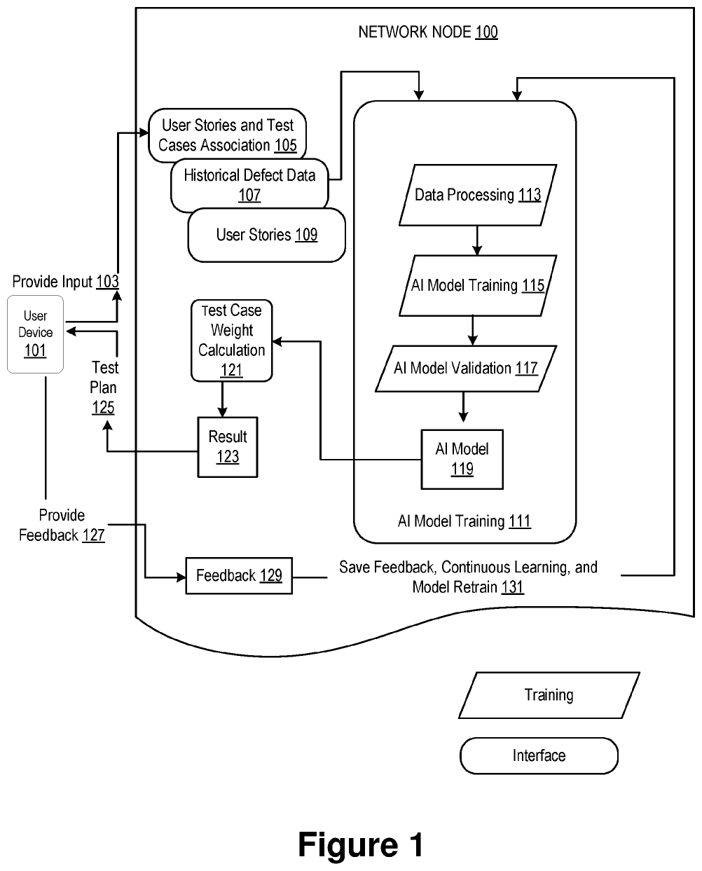

FIG. 1 is a block diagram illustrating operations of a network node 100 in a communication network in accordance with some embodiments of the present disclosure. In the example embodiment of FIG. 1, network node 100 pre-processes 113 raw input data files such as a user story and test case mapping 105, defect data 107, and user stories 109 to generate data in machine understandable format. Features are extracted from the data in machine understandable format (e.g., using relevant fields information from different sources like Release Notes, a defects dump, a test case dump, a test stub, test data etc.) for visualizing or identifying criticality insights in results 123. The operations of network node 100 may be performed automatically to produce a ranking in a displayable format (e.g., test plan report 125) by analyzing the machine understandable format of input data 105, 107, 109. The input data includes, without limitation, historical defect data, and existing and current user stories.

Still referring to the example embodiment of FIG. 1, a user device 101 provides 103 certain inputs towards network node 100 to generate a ranking of test cases 123. Network node 100 can accept, without limitation, user stories 109, test cases mapping with user stories 105, and historical defect data 107. Test case mapping with user stories 105 associate a test case(s) that is a part of a user story for traceability of test cases to user stories. An example of a user story is “Activation of postpaid customer to a network node”; and test cases descriptions mapped to the user story can include “Create Postpaid Customer”, “Create Contract”, “Choose Postpaid Rate Plan”, etc.

An example of a test case includes the following field information, with the names of fields identified before each colon (“: ”), and an example description of each field following each colon:
User Story: US010
Test Case ID: TC001_ETL
Category: Functional
HLD Ref./LLD Ref.: HLD Reference Section 5.1, LLD Reference Section 6
Requirement/Functionality: An aggregation of data. When implementing an aggregation, a mechanism can be used that is resource and time efficient
Test Case Description: Validate summarization management configuration for new partitions weekly and monthly time periods
Environment: Quality Assurance (QA)
Regression: Yes
Priority: High
Pre-Condition: 1. Access to PostgreSQL
Test Step Description: 1. Login to Inventory Database (Db)—PgAdmin; 2. Navigate to etl schema; 3. Check for the table etl.summarization_events_config; 4. Check for the table fields, structure; 5. Check Weekly, Monthly summarization job for presence of any adaptation in the summarization event config table
Expected Behavior: 1. User should be Logged Successfully; 2. etl schema should be present; 3. ‘1 etl.summarization_events_config table should be present; 4. It should be as per the attached sheet; 5. Entry for Weekly, Monthly summarization should be present
Status (Pass/Fail): Pass or Fail
Bug Id: If applicable
Tester: xxxxx
Remarks: If applicable

The input data 105, 107, 109 can be written in different languages such as Spanish, Portuguese, English, etc. Network node 100 pre-processes 113 the data 105, 107, 109 into a machine understandable format. A predefined set of words does not need to be used, but rather network node 100 can analyze an entire text content. A primarily syntactic analysis (e.g., using an AI-based natural language processor (NLP)) may be employed to extract an unordered list of features that together analyzes the user stories 109, historical defect data 107, and test case mapping 105. Model training 115 is performed using an AI-based SVC classifier on the pre-processed data, and the model is validated 117. During model training 117, the SVC classifier calculates weightages of the user stories.

Still referring to FIG. 1, the weightages from the SVC classifier are provided to program code 121 (e.g., TPCI program code written in Python). At least one processor executes program code 121 to calculate further weightages. In calculating the further weightages, defects severities and a number of defects found for user stories are considered. Result 123, including further analyses as described further herein, are generated. Result 123 includes, without limitation, the further weightages against each user story and result 123 is sent in a displayable format (e.g., in .xlsx format) 125 to user 101. The displayable format 125 may be reviewed and considered for a regression test suite. The program code 121 can include additional flexibility to plan test cases for a new sprint where execution of the program code 121 by at least one processor includes test cases for newly deployed user stories in the displayable format 125 as well. Displayable format 125 may guide a user 101 to quickly select most impactful user stories of an application by identifying critical areas based on the calculated and identified weightage. Feedback 117, 129 also may be provided by the user 101, which may help in continuous learning and retraining 131 of program code 121 and the SVC classifier.

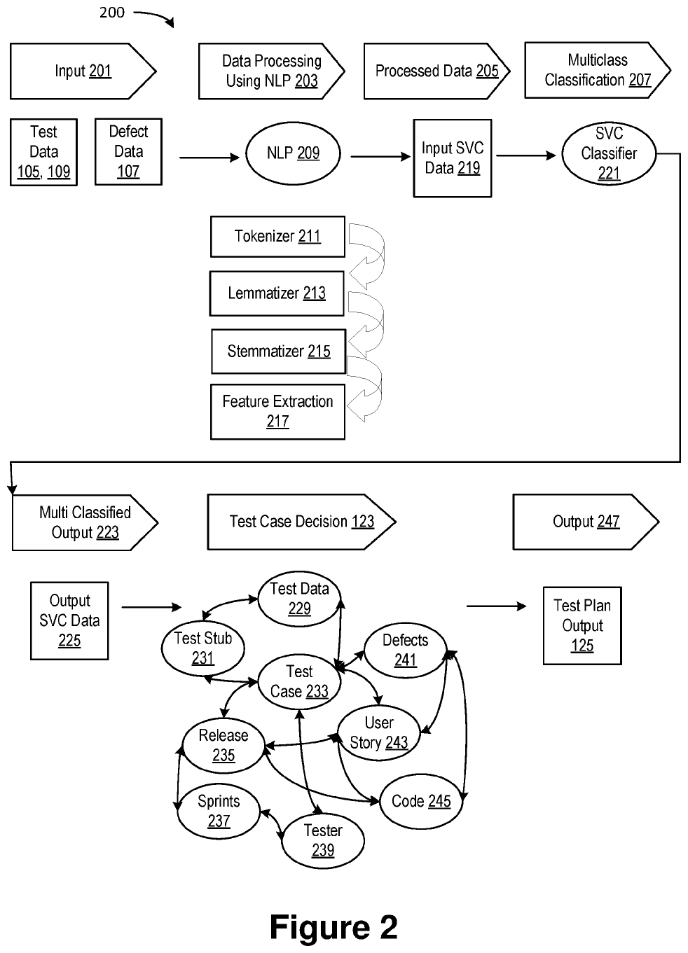

The operations of the example embodiment of FIG. 1 will now be discussed in further detail with reference to FIG. 2. FIG. 2 is a flowchart 200 illustrating operations of a network node in accordance with some embodiments of the present disclosure. User 101 provides input paths or files along with defect severity parameters used in a project (e.g., defect data 107 and user stories 109). In some embodiments, a user story and test case mapping 105 can also be provided. The data is input 201 to network node 100. The input data may be in an Excel format.

For example, an Excel file for test data, e.g., Test data_US.xlsx, may include the following field information, with names of fields in the columns identified in the first row and a description of each filed provided in the second row:

| | | | | | | |
|---|---|---|---|---|---|---|
| | User | | | | | |
| | Story | User Story | | Release | | Story |
| Date Created | ID | Title | Module | Number | Priority | Point |

| | | | | | |
|---|---|---|---|---|---|
| When a user | E.g., the | A Summary of | Impacted | User Story | The |
| story (US) is | JIRA ID | the | Component | meant for | significance |
| prepared | | Requirement | | which | of use |
| | | | | release | |

In some embodiments, as part of development of program code 121 and the SVC Classifier, the User Story Id and Module fields are used by the SVC classifier; and the Date Created, Release Number, Priority, User Story Title, and Story Point fields are used by program code 121.

Additionally, a file containing defect data, e.g., an Excel file Defect_Data.xlsx, may include the following field information, with names of fields in the columns identified in the first row and a description of each filed provided in the second row:

| Defect ID | User Story ID | Defect Title | Severity |
|---|---|---|---|
| E.g., Jira Id | Mapped User Story | Summary of the | The Impact |
| for Defect | for the raised Defect | raised defect | of the defect |

In some embodiments, as part of development of program code 121 and the SVC Classifier, the Defect Id, Severity fields are used by the SVC classifier; and all fields are used by program code 121.

In the example embodiment of FIG. 2, these files are input 201 to AI-based NLP 209 for data preprocessing. NLP 209 is an artificial intelligence algorithm in which a computer/processor(s) intelligently analyzes, comprehends, and infers meaning from human language. NLP 209 can pick up values from the user input data; and can be trained with testing domain expertise to pick only data (e.g., from columns of an input data Excel file) which are related to find out impactful areas of the application. NLP 209 includes techniques to find relevant column names from the user input data. NLP 209 can also help to identify similar data (e.g., similar columns) if exact matching data (e.g., columns) are not present in the input data, e.g., by splitting input data into words, parsed, normalized, tokenized, and processed using part of speech (POS) tagging, entity resolution, synonyms handling, before further processing. NLP 209 can also compute relevancy scores for the text using a bag of words model and text semantic similarity metrics using cosine distance.

For example, using natural language processing, NLP 209 performs tokenization 211, which breaks raw text into words and/or sentences called tokens. These tokens help in understanding the context or developing the NLP model. NLP 209 can also then perform lemmatization 213 with the use of a vocabulary and morphological analysis of words, which normally may aim to remove inflectional endings only and to return the base or dictionary form of a word, which is known as the lemma.

Following lemmatization 213, stemming 215 can be performed, which essentially is a process of reducing a word to its word stem that affixes to suffixes and prefixes or to the roots of words. Next, feature extraction 217 can be performed to extract and produce feature representations that are appropriate for the type of NLP task that is to be accomplished with the NLP model 209.

The processed data file 219 (e.g., named Input_SVC.xlsx) output from NLP 209 includes distinct functional modules which are identified by NLP 209, and the file 219 is an input for the SVC Multiclass classifier 221 to calculate the “One-to-Rest” classification for weightage of the Test Cases.

In some embodiments, the file 219 includes the following field information, with names of fields in the columns identified in the first row and a description of each filed provided in the second row:

| Defect | User Story | | | | | | |
|---|---|---|---|---|---|---|---|
| ID | ID | Defect Title | Module | P1 | P2 | P3 | P4 |
| E.g., | E.g., User | Defect Summary | Module Predicted | Defect Severities | | | |
| JIRA | Story ID in | | and assigned by | | | | |
| ID for | JIRA | | NLP | | | | |
| Defect | | | | | | | |

Pre-processed data 219 is input to SVC classifier 221, which performs multiclass classification 207. Multiclass classification 207 can include, without limitation, a polynomial kernel function, regularization, and calculating weightages for the test cases based on “one-vs-one” classifiers to a “one-vs-rest” decision function of shape. In an n-dimensional space, a goal of a SVM multiclass classifier is to identify a hyperplane that optimizes the separation of data points from their true classes. An objective is to classify as many data points correctly as possible by maximizing the margin from support vectors to the hyperplane while minimizing the term.

During training, where the output file 219 from data preprocessing that is input to the SVC classifier. The SVC classifier can use a polynomial kernel function that represents the similarity of vectors (training samples) in a feature space over polynomials of the original variables thereby allowing learning of non-linear models. Regularization can also be done, using a regularization parameter (lambda) that serves as a degree of importance that is given to misclassifications. Calculation of test case weightage is done based on “one-vs-one” classifiers to a “one-vs-rest” decision functions of shape.

The following advanced logic (e.g., reusable functions) primarily can be used to anticipate the impactful test cases (e.g., most impactful) across an application.

An AI or machine learning (ML) algorithm of the SVC classifier calculates the weightage based on the following:

wj=n/knj
Where,
wj→weight of class j,
n→no of observations
k→total no of classes
nj→no of observations in class j

In some embodiments, the AI-based SVC classifier model 221 learns a domain (e.g., events in a 5G communication network) to assign newly deployed user stories that do not have flaws that have been discovered assigned a higher weight than a weight assigned by the SVC classifier to user stories having discovered flaws. For example, the SVC classifier 221 extracts new user stories from a user-supplied input file by reading the creation dates. Despite the fact that the user stories are fresh, and no flaws have been discovered, the SVC classifier model 221 can continue to find and rank them.

To assess the effect of defects with related test cases, the SVC classifier model 221 can learns from the presence of a bug with the severity, creation date, status, and frequency of occurrence in previous final verification tests, releases, and so on. A prediction from the SVC classifier 221 works based on the supplied weights and their effects on previous releases. Unlike human intuition, this skill can be measured. The output of the SVC classifier 221 may help ensure accurate test cases to consider which may cover the most defect prone areas of the application under test.

After calculating the weightages based on the SVC classifier 221 in support vector machine (SVM), the output 225 of the SVC classifier 221 is provided 223 to at least one processor which executes program code 121 to generate a decision 123 based on one or more factors. The output 225 is provided to program code 121 for predicting test cases based on the one or more factors.

A processor(s) executes program code 121 to make decision 123 based on a volume, variety, and velocity of influential factors (e.g., artefacts and parameters) for identifying potential test cases, and based on overstating/understating input factors in further weightages that are calculated using program code 121. The factors include, without limitation, test data 229, a test stub 231, a test case 233, a release 235, a sprint(s) 237, a tester 239, defects 241, a user story 243, and code 245 for an application. The result 123 includes a ranking of the test cases based on the decision taken. This may help the method to constantly learn from every sprint/release. Additionally, test cases can be profiled using a some scoring mechanism, e.g.: A lookup for test cases count; identifying the number of times the test case is executed; a number of defects uncovered by the test case; covering reusability of a test case's test stub utilization; identifying and analyzing code coverage of a test case; minimizing (potentially significantly) domain knowledge of a human tester. The method of some embodiments can combine AI/ML, automation and domain knowledge of a quality assurance (QA) lead/test manager under same hood.

In a multivendor project, testers often do not have access to code base. Therefore, in a practical scenario, in various embodiments of the present disclosure, a tester can analyze accessible artefacts and parameters for identifying impactful test cases while creating a test plan, which may commonly occur in telecommunications multivendor projects).

In some embodiments, a formula is used to determine a prioritization value from values assigned to each factor for each test case during analysis phase, which can evolve continually during a test planning process. The prioritization value of a test case is calculated as:

$$TP = {\sum }_{i = 1}^{n} ( {PFvalue}_{i} * {PFweight}_{i} )$$

Where:TP=Prioritization value calculated from program code 121;
n=Number of factors influencing the test cases;
PF valueᵢ=Value assigned to each test case based on story points of a linked user story. A weight of each factor; and
PF weightᵢ=Weight assigned to each Test Cases by SVC classifier 221

In some embodiments, decision 123 of impactful test cases is provided in an analysis result column of a test plan report. For example, an analysis result may be provided using the following format:

Defect Count -1
Defect Severity (P1>=1, P2>1, P3>2, P4>3) − P1>=1
Priority - 2
Story Point - 10
Creation Date (<10 Days) - 0

While the above example illustrates an analysis result for five factors (defect count, defect severity, priority, story point, and creation date), the invention is not so limited, and any number of factors can be included and/or a different format for the analysis may be provided.

In some embodiments, the ranking of impactful test cases is output 247 to perform automatic testing of the test case. In some embodiments the output 247 is in a displayable format 125 (e.g., a test plan report in Excel format).

In some embodiments, the displayable format 125 includes the following field information, with names of fields in the columns identified in the first row and a description of each filed provided in the second row:

| User | | | | | | Weightage | | | |
|---|---|---|---|---|---|---|---|---|---|
| Story | | | | | | (from program | Recommended | | |
| ID | P1 | P2 | P3 | P4 | SVC_US_Weightage | code 121) | For Regression | Analysis | Ranking |
| E.g., | Defect | | | | Weightage | Prioritization | Final Outcome | Analysis | Ranked |
| JIRA | Severity | | | | from SVC | value | of program code | Result | user |
| ID for | | | | | classifier | | 121 for impactful | | stories |
| user | | | | | | | test cases | | |
| story | | | | | | | | | |

Some embodiments further include a feedback operation for learning from a user's experience. If a user notices any inconsistencies or areas for improvement after receiving the test case ranking, the user can provide feedback on the produced output. The method can learn from the feedback and provide new weightages accordingly from a next execution onwards.

Implementation and deployment of a network node and/or its components will now be discussed. For example, network node 100 and/or its components can be implemented or integrated in an Agile-DevOps framework, and may be a game changer across the testing competency. The method of some embodiments can process and generate an output file 125 signifying impactful and criticality insights of an application, which then can be automatically executed and/or automatically trigged via email to respective stakeholders. The method of various embodiment may require less human intervention by using an automation script to help process unstructured data from different projects and convert them to machine readable format input that is used in the method. Implementation of the network node and/or program code 121 in different projects may be easier than some approaches as it does not depend upon code for an application.

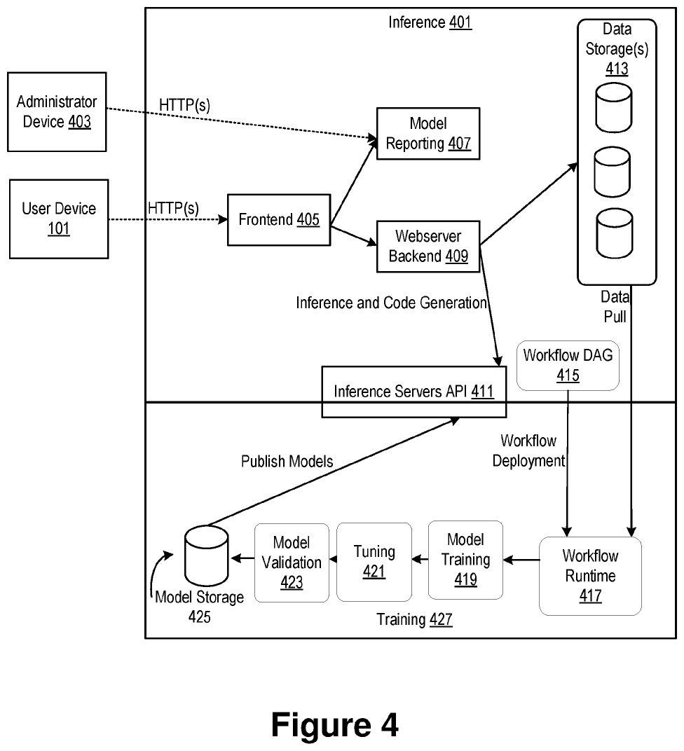

FIG. 4 is a block diagram illustrating a deployment structure in accordance with some embodiments of the present disclosure. The example deployment structure of FIG. 4 includes a deployment structure for inference 401 operations and for training 427 operations. The deployment structure for inference 401 operations include frontend 405, mode reporting 407, webserver backend 409 inference servers/application interfaces (APIs) 411 (which is also included in the deployment structure for training 427 operation), data store(s) 413 and workflow directed acyclic graph (DAG) nodes 415 (which also can also include scheduling operations). The deployment for training 427 operations includes workflow runtime node 417 (which performs,e g., model training 419, hyperparameter tuning 421, model validation) and, and model storage 425.

Still referring to FIG. 4, frontend 405 comprises a user interface to allow user devices 101 to interact with the system of FIG. 4. Frontend 405, for example, may typically be built with responsive web design or as a progressive web application. Webserver Backend 409 provides application interfaces (APIs) that may be needed for search/upload/feedback and any other concerns of the application. Webserver backend 409, for example, typically may be implemented with asynchronous non-blocking input-output (IO). Workflow DAG 415 includes directed acyclic graphs for implementing training and inference workflows used with the method. Workflow Runtime 417 includes an execution environment for running the training and inference workflows. Workflow Tasks performed by workflow runtime 417 include model training 419, hyper parameter tuning 421, and model validation 423, which are performed to train, tune, and validate the model (e.g., optimal performance). Inference Servers/API 411 include hosted inference APIs using the trained model. Reporting Servers 407 perform operators to periodically review model performance and capture metrics.

While the example deployment environment of FIG. 4 illustrates an implementation of deployment, the invention is not so limited. Example deployment environments include, without limitation, 4G, 5G, and 6 G environments and projects.

An empirical evaluation of the method of various embodiments of the present disclosure was performed on a telecommunications network use case.

The method and components of various embodiments of the present disclosure can be used to identify a regression test suite for a release of a development project (e.g., an application). In some embodiments, the components can be extended (e.g., seamlessly) for another project that covers attributes used in a current model. Performance measurements can include a measure of accuracy, which identifies regression test cases having a recall of a specified percentage and a macro-F1 score of a specified percentage.

In accordance with some embodiments, precision, recall, and F1 score are calculated and used to measure the performance of the method as these metrics put more weight on true positive predictions which are considered to be of most importance. Precision (equation 1 below) denotes the number of correctly predicted impactful test cases divided by the total number of the available test cases (e.g., in a repository). This indicates how many of the selected items are relevant. Recall (equation 2 below) is the number of correctly generated test scripts divided by the total number of the existing test scripts. This indicates how many of the relevant items are selected. F1-score (equation 3 below) is a harmonic mean between precision and recall which measures a model's accuracy on a dataset.

$$Precision = \frac{True Positive}{True Positive + False Positive} \qquad Equation 1$$

$$Recall = \frac{True Positive}{True Positive + False Positive} \qquad Equation 2$$

$$F 1 score = 2 \frac{Precision * Recall}{Precision + Recall} \qquad Equation 3$$

Use of Equations 1, 2, and/or 3 may help to evaluate the performance of the method of various embodiments. The method has been trained on a corpus of 400 test cases, 200 user stories, and over 1,000 defects. Using Equations 1, 2, and 3 of the corpus, and by applying different threshold boundaries and processing program code 121, a highest value of F1 Score=82.75% was obtained for a threshold set to 0.1, and the precision score was 84.62% and the recall score was 85.26%, respectively. Moreover, balanced accuracy, which is measured as the average of the proportion corrects of each class individually, was equal to 92%, including performance measurements of the method used in the corpus of test cases.

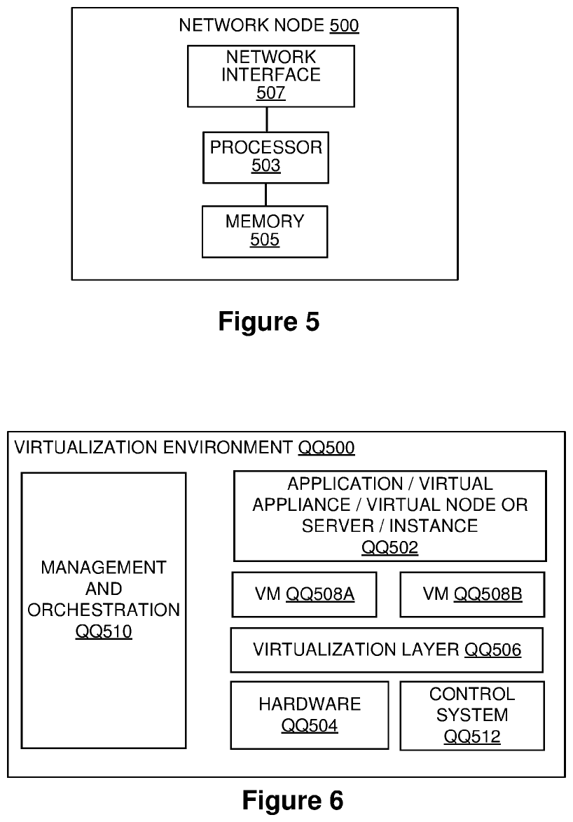

FIG. 5 is a block diagram illustrating elements of a network node 500 of a communication network (e.g., wireless communication network, a wired communication network, etc. as discussed further herein) according to embodiments of the present disclosure. A network node refers to equipment capable, configured, arranged, having modules configured to and/or operable to communicate directly or indirectly with a communication device, data repository, and/or with other network nodes or equipment, in a communication network. Examples of network nodes include, but are not limited to, servers, access points (APs) (e.g., radio access points), base stations (BSs) (e.g., radio base stations, Node Bs, evolved Node Bs (eNBs) and NR NodeBs (gNBs)). Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), Minimization of Drive Tests (MDTs), and/or cloud-implemented servers or edge-implemented servers.

Network node 500 may be provided, for example, as discussed herein with respect to network node 101 of FIG. 1, a cloud-implemented network node (e.g., a server) or located in the cloud or an edge-implemented network node (e.g., a server), a virtual machine in a cloud deployment, or the network node can be distributed over several virtual machines, containers, or function as a service (FaaS) procedures, all of which should be considered interchangeable in the examples and embodiments described herein and be within the intended scope of this disclosure, unless otherwise noted. The method of various embodiments comprise an event-driven method based on incoming requests and delivers outgoing events including, e.g., a ranking of test cases, test descriptions, and test scripts. All components/modules in FIG. 1 can be distributed in a cloud environment, with suitable events between them.

For ease of discussion, a network node will now be described with reference to FIG. 5. As shown, the network node may include transceiver circuitry (not illustrated) including a transmitter and a receiver configured to provide uplink and downlink radio communications with mobile terminals. The network node may include network interface circuitry 507 (also referred to as a network interface) configured to provide communications with other nodes (e.g., with other network nodes, communication devices, and/or data repositories) of the communication network. The network node may also include processing circuitry 503 (also referred to as a processor) coupled to the transceiver circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the network node may be performed by processing circuitry 503, network interface 507, and/or transceiver. For example, processing circuitry 503 may control transceiver to transmit downlink communications through transceiver over a radio interface to one or more mobile terminals UEs and/or to receive uplink communications through transceiver from one or more communication devices over a radio interface. Similarly, processing circuitry 503 may control network interface 507 to transmit communications through network interface 507 to one or more other network nodes and/or to receive communications through network interface from one or more other network nodes, communication devices, etc. Moreover, modules may be stored in memory 505, and these modules may provide instructions so that when instructions of a module are executed by processing circuitry 503, processing circuitry 503 performs respective operations (e.g., operations discussed herein with respect to example embodiments relating to network nodes). According to some embodiments, network node 500 and/or an element(s)/function(s) thereof may be embodied as a virtual node/nodes and/or a virtual machine/machines.

According to some other embodiments, a network node may be implemented as a core network node without a transceiver. In such embodiments, transmission to a communication device, another network node, etc. may be initiated by the network node 500 so that transmission to the communication device, network node, etc. is provided through a network node 500 including a transceiver (e.g., through a base station or radio access network (RAN) node). According to embodiments where the network node is a RAN node including a transceiver, initiating transmission may include transmitting through the transceiver.

Embodiments of the network node may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

Although network node 500 is illustrated in the example block diagram of FIG. 5, the block diagram may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of a network node are depicted as single boxes located within a larger box, or nested within multiple boxes, in practice, each device may comprise multiple different physical components that make up a single illustrated component (e.g., a memory may comprise multiple separate hard drives as well as multiple RAM modules).

Example communication networks may include and/or interface with any type of communication, telecommunication, data, cellular, radio network, and/or other similar type of system including, but not limited to, a 4G, 5G and/or 6G network. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication network may include any number of wired or wireless networks, network nodes, communication devices, and/or any other components or systems that may facilitate or participate in the communication of data and/or signals whether via wired or wireless connections.

As a whole, the communication network enables connectivity between communication devices, network nodes, hosts, data repositories, etc. In that sense, the communication network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5 G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network is a cellular network that implements 3GPP standardized features. Accordingly, the communications network may support network slicing to provide different logical networks to different devices that are connected to the communication network. For example, the communications network may provide Ultra Reliable Low Latency Communication (URLLC) services to some communication devices, while providing Enhanced Mobile Broadband (eMBB) services to other communication devices, and/or Massive Machine Type Communication (mMTC)/Massive IoT services to yet further communication devices.

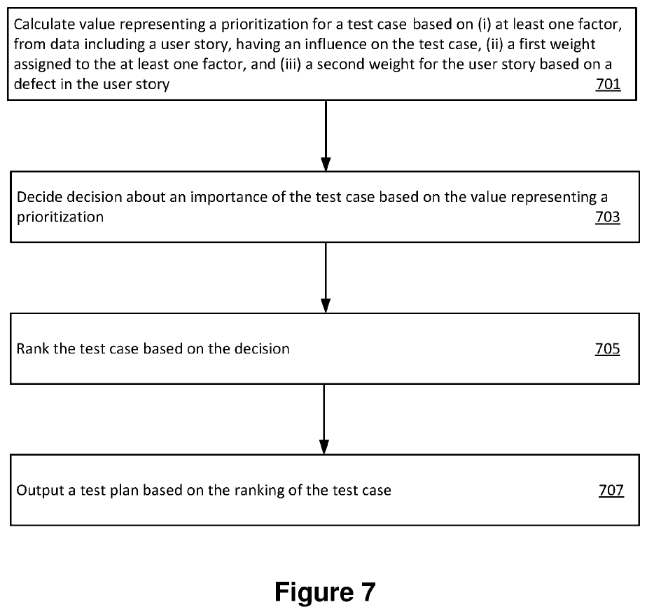

FIG. 6 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, communication device, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the network nodes described herein (e.g., servers, etc.) may include the illustrated combination of hardware components, other embodiments may comprise computing devices with different combinations of components. It is to be understood that these network nodes may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, communication devices and network nodes may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the communication devices and/or network nodes as a whole, and/or by end users and a wireless network generally.

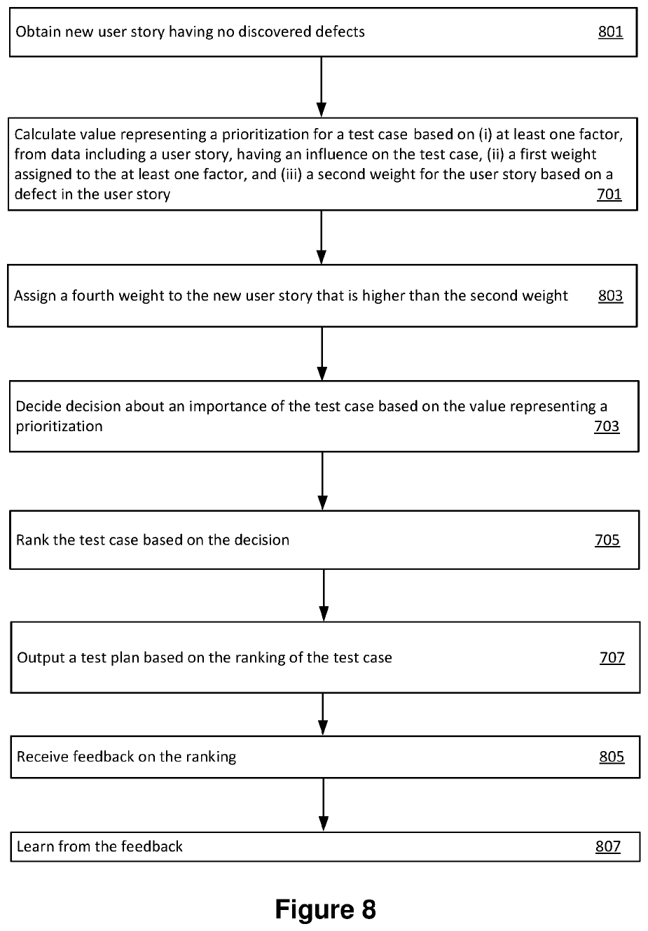

Operations of a network node (e.g., network node 101) (implemented using the structure of FIG. 5) will now be discussed with reference to the flow charts of FIGS. 7 and 8 according to some embodiments of the present disclosure. In the description that follows, while the network node may be any of the network node 101, a virtual machine, a distributed over more than one virtual machine, the network node 500 shall be used to describe the functionality of the operations of the network node. For example, modules may be stored in memory 505 of FIG. 5, and these modules may provide instructions so that when the instructions of a module are executed by respective network node processing circuitry 503, processing circuitry 503 performs respective operations of the flow chart.

Referring to FIG. 7, a method automatically performed by a network node for ranking test cases for a test of a release of an application in a communication network is provided. The method includes calculating (701) a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story. The method further includes deciding (703) a decision about an importance of the test case based on the value representing a prioritization for the at least one test case. The method further includes ranking (705) the test case based on the decision. The method further includes outputting (707) a test plan based on the ranking of the test case.

In some embodiments, the data for the test case further comprises at least one of a defect in a release of the application, and a mapping between the test case and the user story.

In some embodiments, the data for the test case further comprises at least one of a release identifier for the application, a priority for the test case, a value representing a story point of the user story, a creation date of the test case, a test stub for the test case, a number of sprints for the test case, a tester for the test case, and a program code for a release of the application.

In some embodiments, the user story comprises at least one parameter comprising a severity of a defect for the user story, a story point for the user story, a creation date for the user story, a deployed date for the user story, and a time period for a sprint for the user story.

In some embodiments, the data for the test case is in a machine readable format. The machine readable format is obtained from a process that transformed the data in at least one natural language to the machine readable format.

In some embodiments, the value representing the prioritization for the test case comprises a third weight. The third weight comprises a severity based defect distribution in the in data for the test case and a number of defects found in the data for the test case.

In some embodiments, the second weight for the user story based on a defect in the user story is obtained from a classifier process that comprises an artificial intelligence support vector classifier that classifies the user story based on a severity of a defect in the user story.

In some embodiments, the decision comprises an analysis that assigns a value to the at least one factor.

Referring now to FIG. 8, in some embodiments, the method further includes obtaining (801) a new user story, the new user story having no discovered defects. The method further includes assigning (803) a fourth weight to the new user story that is higher than the second weight.

In some embodiments, the method further includes receiving (805) feedback on the ranking. The method further includes learning (807) from the feedback. The learning includes repeating for another test case the calculating a value representing a prioritization, the deciding a decision about an importance of the test case, and the ranking the test case based on the decision.

In some embodiments, the application is a control system supporting the communication network.

In some embodiments, the communication network is a wireless network.

In some embodiments, the outputting (707) the test plan comprises at least one of displaying the test plan and executing the test plan in an automatic way.

In some embodiments, the test plan comprises a score reflecting a confidence level in the ranking of the test case.

In some embodiments, the displaying the test plan comprises signalling the test plan to one of a display interface and a user via an electronic notification.

Various operations from the flow chart of FIG. 8 may be optional with respect to some embodiments of a method performed by a network node. For example, operations of blocks 801-807 of FIG. 8 may be optional.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method automatically performed by a network node for ranking test cases for a test of a release of an application in a communication network, the method comprising:
calculating (701) a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story;
deciding (703) a decision about an importance of the test case based on the value representing a prioritization for the at least one test case;
ranking (705) the test case based on the decision; and
outputting (707) a test plan based on the ranking of the test case.

2. The method of claim 1, wherein the data for the test case further comprises at least one of a defect in a release of the application, and a mapping between the test case and the user story.

3. The method of claim 2, wherein the data for the test case further comprises at least one of a release identifier for the application, a priority for the test case, a value representing a story point of the user story, a creation date of the test case, a test stub for the test case, a number of sprints for the test case, a tester for the test case, and a program code for a release of the application.

4. The method of claim 1, wherein the user story comprises at least one parameter comprising a severity of a defect for the user story, a story point for the user story, a creation date for the user story, a deployed date for the user story, and a time period for a sprint for the user story.

5. The method of claim 1, wherein the data for the test case is in a machine readable format, the machine readable format obtained from a process that transformed the data in at least one natural language to the machine readable format.

6. The method of claim 1, wherein the value representing the prioritization for the test case comprises a third weight, the third weight comprising a severity based defect distribution in the in data for the test case and a number of defects found in the data for the test case.

7. The method of claim 1, wherein the second weight for the user story based on a defect in the user story is obtained from a classifier process that comprises an artificial intelligence support vector classifier that classifies the user story based on a severity of a defect in the user story.

8. The method of claim 1, wherein the decision comprises an analysis that assigns a value to the at least one factor.

9. The method of claim 1, further comprising:
obtaining (801) a new user story, the new user story having no discovered defects; and
assigning (803) a fourth weight to the new user story that is higher than the second weight.

10. The method of claim 1, further comprising:
receiving (805) feedback on the ranking; and
learning (807) from the feedback, wherein the learning comprises repeating for another test case the calculating a value representing a prioritization, the deciding a decision about an importance of the test case, and the ranking the test case based on the decision.

11. The method of claim 1, wherein the application is a control system supporting the communication network.

12. The method of claim 1, wherein the communication network is a wireless network.

13. The method of claim 1, wherein the outputting (707) the test plan comprises at least one of displaying the test plan and executing the test plan in an automatic way.

14. The method of claim 1, wherein the test plan comprises a score reflecting a confidence level in the ranking of the test case.

15. The method of claim 13, wherein the displaying the test plan comprises signalling the test plan to one of a display interface and a user via an electronic notification.

16. A network node (100, 500) for automatically performing ranking of test cases for a test of for a release of an application in a communication network, the network node comprising:
at least one processor (503);
at least one memory (505) connected to the at least one processor (503) and storing program code that is executed by the at least one processor to perform operations comprising:
calculate a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story;
decide a decision about an importance of the test case based on the value representing a prioritization for the at least one test case;
rank the test case based on the decision; and
output a test plan based on the ranking of the test case.

17. A network node (100, 500) for automatically performing ranking of test cases for a test of for a release of an application in a communication network, the network node comprising:
at least one processor (503);
at least one memory (505) connected to the at least one processor (503) and storing program code that is executed by the at least one processor to perform operations comprising:
calculate a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story;
decide a decision about an importance of the test case based on the value representing a prioritization for the at least one test case;
rank the test case based on the decision; and
output a test plan based on the ranking of the test case;
wherein the at least one memory (505) is connected to the at least one processor (503) and storing program code that is executed by the at least one processor to perform operations according to claim 2.

18.-22. (canceled)

23. A computer program product comprising a non-transitory storage medium including program code to be executed by processing circuitry (503) of a network node (100, 500), whereby execution of the program code causes the network node to perform operations comprising:
calculate a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story;
decide a decision about an importance of the test case based on the value representing a prioritization for the at least one test case;
rank the test case based on the decision; and
output a test plan based on the ranking of the test case.

24. A computer program product comprising a non-transitory storage medium including program code to be executed by processing circuitry (503) of a network node (100, 500), whereby execution of the program code causes the network node to perform operations comprising:
calculate a value representing a prioritization for a test case based on (i) at least one factor having an influence on the test case, the at least one factor obtained from data for the test case and the data including a user story, (ii) a first weight assigned to the at least one factor, and (iii) a second weight for the user story based on a defect in the user story;
decide a decision about an importance of the test case based on the value representing a prioritization for the at least one test case;
rank the test case based on the decision; and
output a test plan based on the ranking of the test case;
wherein execution of the program code causes the network node to perform operations according to claim 2.
